(19) United States
(12) Patent Application Publication
(10) Pub. No.: US 2012/0024898 A1
(43) Pub. Date: Feb. 2, 2012

(54) CONTAINER

(76) Inventor: Romuald Yip, Illawong (AU)

(21) Appl. No.: 13/193,146

(22) Filed: Jul. 28, 2011

(30) Foreign Application Priority Data
Jul. 30, 2010 (AU) 2010903425

(51) Int. Cl. B67D 7/74; B67D 7/56; A47G 19/14

(52) U.S. Cl. 222/129; 222/158; 222/465.1

(57) ABSTRACT

A container to receive liquid fuel is provided. The container includes a major sub-chamber to receive the fuel, and a measuring chamber that would typically receive an oil to be mixed with the fuel. A throat joins the sub-chambers to enable mixing of the fuel.

The present application is entitled to the benefit of and incorporates by reference essential subject matter disclosed in Australian Provisional Patent Application Serial No. 2010903425 filed Jul. 30, 2010.

### BACKGROUND OF THE INVENTION

1. Technical Field

The present invention relates to containers and more particularly but not exclusively to containers to receive liquid fuel.

2. Background Information

When mixing fuel, typically for two-stroke engines, a container is used into which the fuel is delivered. A lubricant such as oil is mixed with the fuel in a predetermined volumetric ratio. As an example, the volumetric relationship of fuel to oil may be 50:1.

Typically the lubricant is measured in a measuring cup or other hollow measuring device. The measuring lubricant is delivered to the interior of a container and mixed with the fuel.

A disadvantage of the above discussed container is that it is necessary to provide a separate measuring cup. A further disadvantage is that should no measuring cup be available, frequently a user will approximate the volume of lubricant to be added to the fuel. If this is incorrectly estimated damage to the two-stroke engine may occur.

Disclosed in International PCT/AU2007/001791 is a container for the delivery of liquids. In particular this International application relates to watering cans. It does not provide information relating to a container for the transportation of fuels.

Disclosed in U.S. Pat. No. 5,447,245 is a container within which fuel and oil is to be mixed for the purposes of delivering the mixture to a two-stroke engine. The container has two passages via which the liquids are delivered to the interior of the container. One passage delivers the oil to a metering chamber, while the other passage delivers the fuel to the main body of the container. Joining the chambers is a throat. However the object of the container of the specification is to inhibit liquid passing through the throat. Accordingly a disadvantage of the container is that the throat is relatively small A still further disadvantage is that the passage that delivers liquid to the measuring chamber is not intended to provide for the delivery of the fuel to the other main chamber.

It is the object of the present invention to overcome or substantially ameliorate at least one of the above disadvantages.

### SUMMARY OF THE INVENTION

There is disclosed herein a container to receive a liquid, the container including: a hollow body to receive the liquid, the body having a bottom wall, a side wall, the side wall having at least a part that is light transmissive so that a user can determine the liquid depth adjacent the wall, a partition wall extending upwardly relative to the bottom, and dividing the container internally into a major sub-chamber and a measuring sub-chamber, the measuring sub-chamber being adjacent the side wall and in communication with the main sub-chamber; and a spout providing a passage via which liquid is delivered to the chambers, the spout being above the sub-chambers so as to provide for delivery of liquid from the spout to the measuring sub-chambers, and wherein the passage is the only passage via which liquid is delivered to and from the sub-chambers.

Preferably, the container includes a cap to engage the spout to close the spout.

Preferably, the container includes an air vent.

Preferably, said wall is provided with graduations to aid a user in estimating the volume of liquid in the measuring sub-chamber.

Preferably, the container has a top wall, and a handle attached to the top wall so as to be above the major sub-chamber.

Preferably, the sub-chambers are connected by a throat, said throat having a width and height, said main sub-chamber has a height with the throat height being at least a half of the main sub-chamber height.

Preferably, the throat height is at a quarter of the main sub-chamber height.

Preferably, said partition wall has an upper extremity, said side wall is a first side wall, and the container includes a pair of spaced further side walls between which the first wall extends, with said extremity extending between the further side walls.

Preferably, said passage extends longitudinally toward said extremity, and is inclined to the horizontal by an acute angle.

### BRIEF DESCRIPTION OF THE DRAWINGS

A preferred form of the present invention will now be described by way of example with reference to the accompanying drawings wherein:

FIG. 1 is a schematic isometric view of a container to receive liquid fuel;

FIG. 2 is a schematic sectioned side elevation of portion of the container of FIG. 1;

FIG. 3 is a schematic isometric view of a modification of the container of FIGS. 1 and 2;

FIG. 4 is a schematic planned sectioned view of the container of FIG. 3; and

FIG. 5 is a schematic sectioned side elevation of the container of FIG. 3.

### DETAILED DESCRIPTION OF THE INVENTION

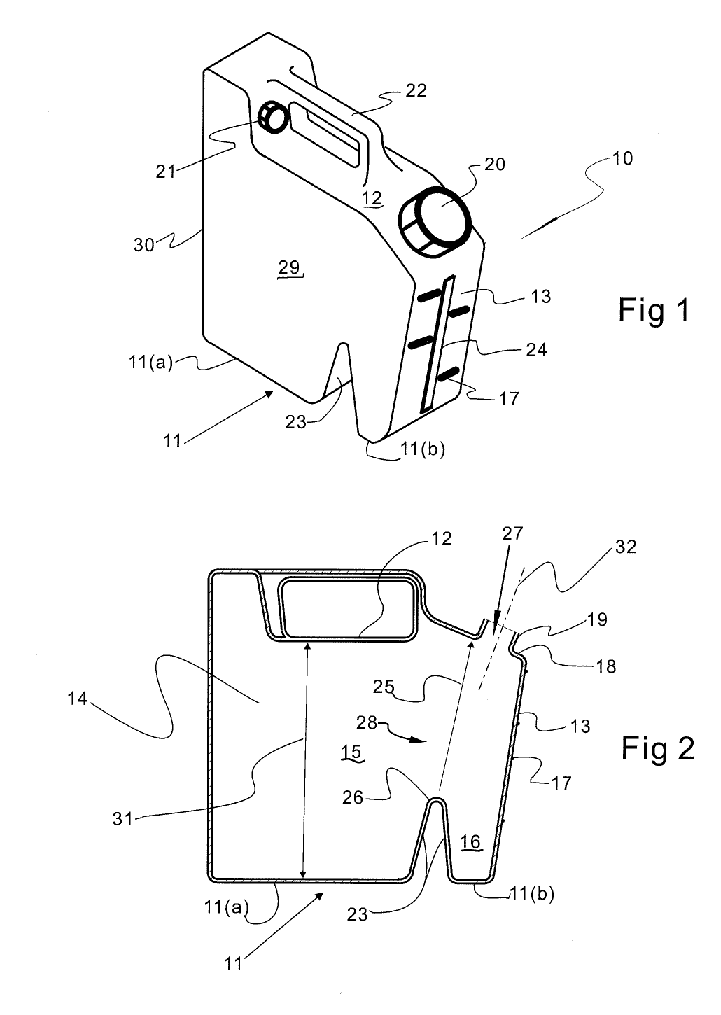

In FIGS. 1 and 2 of the accompanying drawings there is schematically depicted a container 10 to receive liquid fuel. The container 10 is molded from plastics material. Typically the container 10 would be used to mix a liquid fuel with a lubricant. For example, if the container 10 was to provide petrol for a two-stroke engine, the container 10 would receive petrol and a volume of oil to be mixed therewith.

The container 10 includes a bottom wall 11 and a top wall 12 as well as side walls 13, 29 and 30. The walls 11, 12 and 13 at least partly enclose a container chamber 14. The chamber 14 includes a major sub-chamber 15 and a measuring sub-chamber 16. The sub-chamber 16 is adjacent the wall 13.

The wall 13 provides for the transmission of light through at least a part of the wall 13 so that the level of liquid in the measuring sub-chamber 16 may be determined. Preferably, the side wall 13 has a vertical transparent strip 24 through which the liquid can be seen. Typically the wall 13 would be provided with graduations 17 to assist the user in determining the volume of, for example, oil in the measuring sub-chamber 16.

Joining the top wall 12 and side wall 13 is an inclined wall 18 that provides a spout 19. The spout 19 is located above the sub-chamber 16 so that oil may be delivered directly from the spout 19 into the sub-chamber 16 so that the volume of oil may be measured. Thereafter petrol is added to the sub-chambers 15 and 16 and mixed with the oil contained in the sub-chamber 16.

The sub-chambers 15 and 16 are connected so that the petrol and oil can be mixed.

The spout 19 is provided with a cap 20, while the container 10 may also be provided with a vent (closable) 21.

For ease of handling, a handle 22 is provided and is attached to the top wall 12.

The sub-chambers 15 and 16 are partitioned by means of a dividing wall 23 that extends upwardly from the bottom wall 11.

The chamber 14 is essentially sealingly enclosed when the vent 21 is closed and the cap 20 sealingly engaged with the spout 19.

The wall 23 has an upper extremity 26 that extends transversely across the interior of the container, and preferably between the internal surfaces of the walls 29. The upper extremity 26 is also spaced from the top wall 12 by a height 25 so as to provide a throat 28.

The spout 19 provides a passage 27 with a longitudinal axis 32, with the passage 27 and longitudinal axis 32 generally directed at the upper extremity 26 so that when liquid is being delivered to the interior of the container with a reasonable flow rate, the liquid is distributed between the chambers 15 and 16. However when a liquid is delivered to the interior at a slower flow rate, the liquid is delivered to the chamber 16.

Preferably, the height 25 is at least 50% of the height 31. More preferably the height 25 is at least or approximately 25% of the height 31.

The bottom wall 11 includes a bottom wall portion 11(a) and a bottom wall portion 11(b), with at least the bottom wall portion 11(a) providing a surface upon which the container rests.

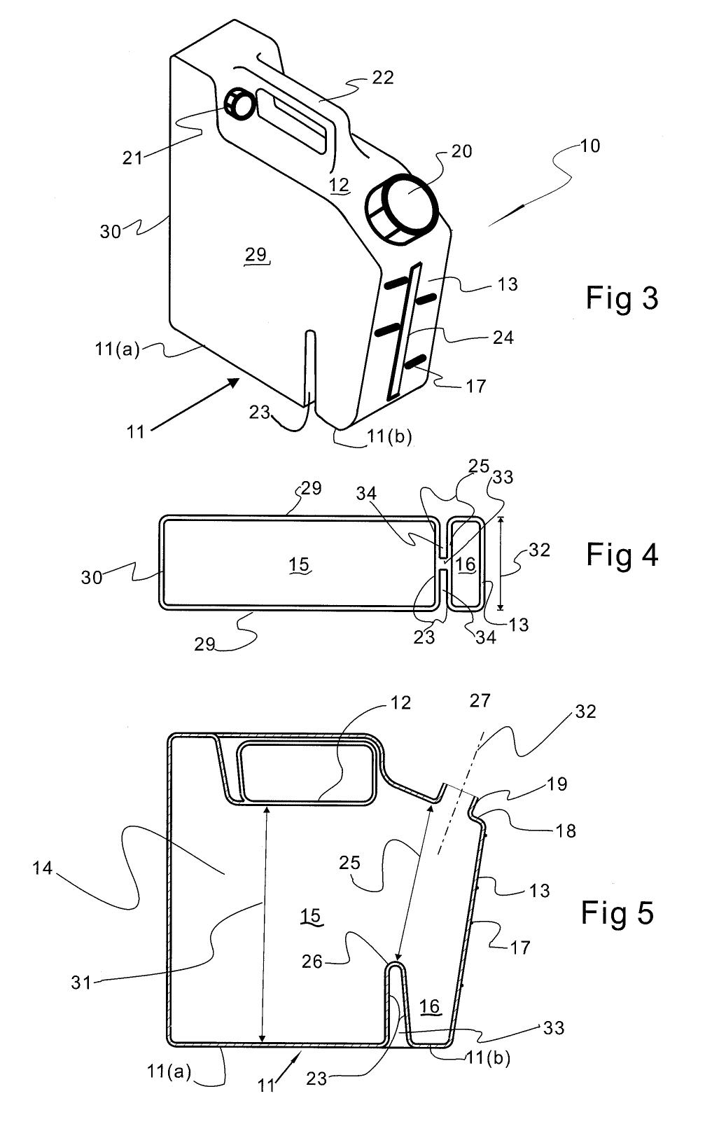

In the embodiment of FIGS. 3 to 5, the wall 23 includes a web 33. Accordingly the wall 23 provides a pair of slots 34 that extend transversely inwardly from the side walls 29 to the central web 33.

Preferably, the transverse width 32 between in the internal surfaces of the side walls 29 is approximately equal the length of the upper extremity 26.

Although this invention has been shown and described with respect to the detailed embodiments thereof, it will be understood by those skilled in the art that various changes in form and detail thereof may be made without departing from the spirit and the scope of the invention.

What is claimed is:

1. A container to receive a liquid, the container comprising:
a hollow body to receive the liquid, the body having a bottom wall, a side wall, the side wall having at least a part that is light transmissive so that a user can determine the liquid depth adjacent the wall, a partition wall extending upwardly relative to the bottom, and dividing the container internally into a major sub-chamber and a measuring sub-chamber, the measuring sub-chamber being adjacent the side wall and in communication with the main sub-chamber; and
a spout providing a passage via which liquid is delivered to the chambers, the spout being above the measuring sub-chamber so as to provide for delivery of liquid from the spout to the sub-chambers, and wherein the passage is the only passage via which liquid is delivered to and from the sub-chambers.

2. The container of claim 1, wherein the container further comprises an air vent.

3. The container of claim 1, wherein said wall is provided with graduations to aid a user in estimating the volume of liquid in the measuring sub-chamber.

4. The container of claim 1, wherein the container has a top wall, and a handle attached to the top wall so as to be above the major sub-chamber.

5. The container of claim 1, wherein the sub-chambers are connected by a throat, said throat having a width and height, said main sub-chamber has a height with the throat height being at least a half of the main sub-chamber height.

6. The container of claim 5, wherein the throat height is at least a quarter of the main sub-chamber height.

7. The container of claim 1, wherein said partition wall has an upper extremity, said side wall is a first side wall, and the container includes a pair of spaced further side walls between which the first wall extends, with said extremity extending between the further side walls.

8. The container of claim 7, wherein said passage extends longitudinally toward said extremity, and is inclined to the horizontal by an acute angle.

9. The container of claim 3, wherein said wall is provided with graduations to aid a user in estimating the volume of liquid in the measuring sub-chamber.

10. The container of claim 9, wherein the container has a top wall, and a handle attached to the top wall so as to be above the major sub-chamber.

11. The container of claim 10, wherein the sub-chambers are connected by a throat, said throat having a width and height, said main sub-chamber has a height with the throat height being at least a half of the main sub-chamber height.

12. The container of claim 11, wherein the throat height is at least a quarter of the main sub-chamber height.

13. The container of claim 12, wherein said partition wall has an upper extremity, said side wall is a first side wall, and the container includes a pair of spaced further side walls between which the first wall extends, with said extremity extending between the further side walls.

14. The container of claim 13, wherein said passage extends longitudinally toward said extremity, and is inclined to the horizontal by an acute angle.

15. The container of claim 1, wherein said wall is provided with graduations to aid a user in estimating the volume of liquid in the measuring sub-chamber, the container has a top wall, and a handle attached to the top wall so as to be above the major sub-chamber, the sub-chambers are connected by a throat, said throat having a width and height, said main sub-chamber has a height with the throat height being at least a half of the main sub-chamber height, the throat height is at a quarter of the main sub-chamber height, said partition wall has an upper extremity, said side wall is a first side wall, and the container includes a pair of spaced further side walls between which the first wall extends, with said extremity extending between the further side walls, said passage extends longitudinally toward said extremity, and is inclined to the horizontal by an acute angle.
